(19) United States
(12) Patent Application Publication
(10) Pub. No.: US 2015/0186508 A1
(43) Pub. Date: Jul. 2, 2015

(54) GENOME ONTOLOGY SCHEME

(71) Applicant: KT Corporation, Gyeonggi-do (KR)

(72) Inventors: Sang-hee KIM, Seoul (KR); Kwang-Joong KIM, Seoul (KR); Mi-Sook LEE, Seoul (KR)

(21) Appl. No.: 14/583,231

(22) Filed: Dec. 26, 2014

(30) Foreign Application Priority Data
Dec. 26, 2013 (KR) 10-2013-0163623

(51) Int. Cl. G06F 17/30; G06F 19/00

(52) U.S. Cl. CPC G06F 17/30734; G06F 17/3053; G06F 17/30528; G06F 19/709

(57) ABSTRACT

In one example embodiment, a genome ontology device may determine one or more super-concepts to be included in an ontology, generate a first genome database, from a genome, that includes at least one first title, at least one first field name and at least one first field value, select, from among the one or more super-concepts, one or more super-concepts that correspond to the first genome database, search web-based sources using at least one first key word associated with the one or more super-concepts and the first database, retrieve, from results of the search, a plurality of sub-concepts subsumed by the one or more super-concepts and one or more respective relationships between the one or more super-concepts and the plurality of sub-concepts, and generate the ontology based on the super-concepts, the retrieved sub-concepts, and the retrieved relationships.

### TECHNICAL FIELD

The embodiments described herein pertain generally to genome ontology schemes.

### BACKGROUND

In ontology, a concept may be regarded as a fundamental category of existence, such as specific titles assigned to idea or entity. Instances may refer to specific figures or events, e.g., substantial embodiments of idea or entity. Any distinction between a concept and an instance may be subject to change depending on the purpose of usage, e.g., context.

### SUMMARY

In one example embodiment, a method performed under control of a genome ontology device may include: determining one or more super-concepts to be included in an ontology; generating a first genome database, from a genome, that includes at least one first title, at least one first field name and at least one first field value; selecting, from among the one or more super-concepts, one or more super-concepts that correspond to the first genome database; searching web-based sources using at least one first key word associated with the one or more super-concepts and the first database; retrieving, from results of the search, a plurality of sub-concepts subsumed by the one or more super-concepts and one or more respective relationships between the one or more super-concepts and the plurality of sub-concepts; and generating the ontology based on the super-concepts, the retrieved sub-concepts, and the retrieved relationships.

In another example embodiment, a genome ontology device may include: a manager configured to determine one or more super-concepts to be included in an ontology; a database generator configured to generate a first genome database, from a genome, that includes at least one first title, at least one first field name and at least one first field values; a selector configured to select, from among the one or more super-concepts, one or more super-concepts that correspond to the first genome database; a searching component configured to search web-based sources using at least one first key word associated with the one or more super-concepts and the first database; a retriever configured to retrieve, from results of the search, a plurality of sub-concepts subsumed by the one or more super-concepts and one or more respective relationships between the one or more super-concepts and the plurality of sub-concepts; and an ontology generator configured to generate the ontology based on the super-concepts, the retrieved sub-concepts, and the retrieved relationships.

In yet another example embodiment, a computer-readable storage medium having thereon computer-executable instructions that, in response to execution, cause a genome ontology device to perform operations may include: determining one or more super-concepts to be included in an ontology; generating a first genome database, from a genome, that includes at least one first title, at least one first field name and at least one first field value; selecting, from among the one or more super-concepts, one or more super-concepts that correspond to the first genome database; searching web-based sources using at least one first key word associated with the one or more super-concepts and the first database; retrieving, from results of the search, a plurality of sub-concepts subsumed by the one or more super-concepts and one or more respective relationships between the one or more super-concepts and the plurality of sub-concepts; and generating the ontology based on the super-concepts, the retrieved sub-concepts, and the retrieved relationships.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system 10 in which one or more genome ontology scheme embodiments may be implemented, in accordance with various embodiments described herein;

FIG. 2 shows an example application by which at least portions of a genome ontology scheme may be implemented, in accordance with various embodiments described herein;

FIG. 3 shows an example application by which at least portions of a genome ontology scheme may be implemented, in accordance with various embodiments described herein;

FIG. 4 shows an example processing flow of operations, by which at least portions of a genome ontology scheme may be implemented, in accordance with various embodiments described herein;

FIG. 5 shows an example embodiment implemented by at least portions of a genome ontology scheme, in accordance with various embodiments described herein; and

FIG. 6 shows an illustrative computing embodiment, in which any of the processes and sub-processes of a genome ontology scheme may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

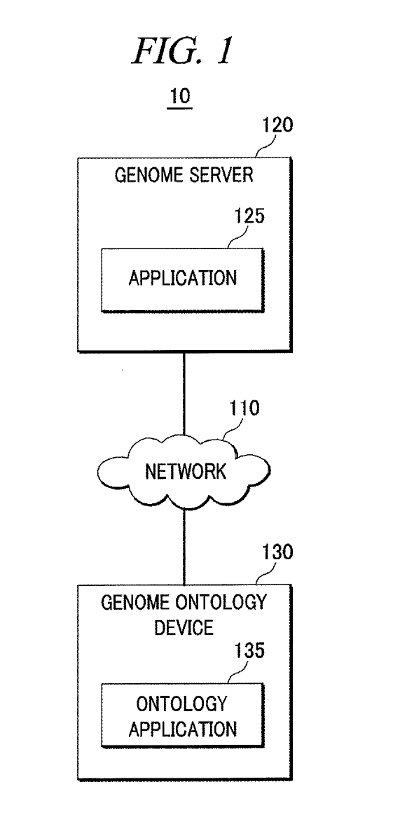

FIG. 1 shows an example system 10 in which one or more embodiments of a genome ontology scheme may be implemented, in accordance with various embodiments described herein. As depicted in FIG. 1, system 10 may include, at least, a genome server 120, and a genome ontology device 130. Genome server 120 and genome ontology device 130 may be communicatively connected to each other via a network 110.

Network 110 may be a wired or wireless information or telecommunications network. Non-limiting examples of network 110 may include a wired network such as a LAN (Local Area Network), a WAN (Wide Area Network), a VAN (Value Added Network), a telecommunications cabling system, a fiber-optics telecommunications system, or the like. Other non-limiting examples of network 110 may include wireless networks such as a mobile radio communication network, including at least one of a 3^{rd}, 4^{th}, or 5th generation mobile telecommunications network (3G), (4G), or (5G); various other mobile telecommunications networks; a satellite network; WiBro (Wireless Broadband Internet); Mobile WiMAX (Worldwide Interoperability for Microwave Access); HSDPA (High Speed Downlink Packet Access); or the like.

Genome server 120 may be a processor-enabled computing device that is configured or operable to store information regarding a user's genome. A genome may refer to the genetic material of an organism, encoded either in DNA (deoxyribonucleic acid) or, for many types of viruses, in RNA (ribonucleic acid). Further, a genome may include both the genes and the non-coding sequences of the DNA/RNA. As referenced herein, a genome may refer to genetic information that is stored on a complete set of nuclear DNA.

Genome ontology device 130 may be a processor-enabled computing device that is configured or operable to automatically generate a genome ontology based on at least a portion of the contents of a plurality of genome databases stored in genome server 120. The genome databases may include at least one title, e.g., name of a particular gene; a plurality of field names, e.g., components of the gene such as a chromosome, the chromosome's position (a position may refer to where a chromosome is located in the corresponding gene and may be expressed by alphanumeric characters), allele (allele is one of a number of alternative forms of the same gene or same genetic locus and that may include alphabet), etc.; and a plurality of field values, e.g., component values or characteristics such as chromosome number that may be expressed in the range of 1 to 46 (a gene may have 22 different types of chromosomes and two sex chromosomes, which are 46 chromosomes in total), and position numbers that may be expressed by numbers and may be defined by Human Genome Project. For example, position number “1001” may indicate that chromosome 1 is located in 1001th place within the gene P, or position number “100” may indicate that chromosome 1 is located in 100^{th} place within the gene P.

First, ontology application 135 that is hosted, executing, or operating on genome ontology device 130 may be configured or operable to retrieve concepts, instances and their relationships from the plurality of genome databases, wherein the concepts may include super-concepts and sub-concepts subsumed by the super-concepts. Then, genome ontology device 130 may generate the genome ontology to produce a structured, precisely defined, common, controlled vocabulary to describe genes and gene products by utilizing the retrieved concepts, the respective inclusive relationships between super-concepts and sub-concepts. Genome ontology device 130 may determine which super-concept may include with sub-concept, and instances that may be values of various sub-concepts, e.g., chromosome numbers, and allele originally used to describe variations among genes.

In some embodiments, ontology application 135 may be further configured or operable to determine one or more super-concepts to be included in an ontology. A super-concept may refer to a higher concept that may be determined by a user input to genome ontology device 130. Non-limiting examples of super-concepts associated with a genome may include diseases, variations, genes, and drugs.

Ontology application 135 may be further configured or operable to generate, after determining one or more super-concepts, a first genome database that may include one or more data tables. The generated data tables may each include a title, a field name including, e.g., a plurality of segments such as chromosome, position, allele, etc., and field values corresponding to the respective segments of the field name.

For example, ontology application 135 may generate a first genome database that includes a data table titled “P” (for gene “P”) and another data table titled “Q” (for gene “Q”). As an example of the data table, data table P may be provided as: a gene P's chromosome, that is packaged and organized chromatin, a complex of macromolecules found in cells, consisting of DNA, protein and RNA and that may have a plurality of chromosome numbers, as a field value; a position of gene P's chromosome within gene P, as gene P's field name, that may indicate where the chromosome is located in gene P and that may be shown in a form of 4 digit numbers (in gene P, there may be many locations where chromosome can be located), as a field value; and an allele, as a field name, that is one of a number of alternative forms of the same gene or same genetic locus and that may include one or more alphanumeric characters as a field value.

Gene P

| chromosome | Position | Allele |
|---|---|---|
| 1 | 1001 | T |
| 1 | 1002 | A |

Ontology application 135 may be further configured or operable to select one or more of the determined super-concepts that correspond to the first genome database. That is, genome ontology device 130 may select a super-concept corresponding to a field name included in a genome database. As a non-limiting example, if the first genome database includes both “data table P” and “data table Q,” each of which may include “Chromosome,” “Position,” and “Allele” as the respective field names, genome ontology device 130 may select “variation” as a super-concept corresponding to “data table P” and “data table Q,” based on a table predefining certain corresponding relationships between field names and super-concepts that indicates that “Chromosome,” “Position,” and “Allele” may be included in “variation” of the corresponding gene.

Ontology application 135 may be further configured or operable to then search web-based information using at least one keyword associated with the selected super-concept and the first database for multiple sentences including the keyword. For example, genome ontology device 130 may generate two keywords including at least one of the titles, the field names, and the field values included “data table P” and “data table Q” and the selected super-concept “variation.” As an example of the two keywords, ontology application 135 may generate the keywords including “chromosome” and “variation” to be used to search for the multiple sentences including the keywords that may produce a structured, precisely defined vocabulary for describing the roles of genes and gene products.

Then, to produce a structured, precisely defined vocabulary to describe the genes and gene products, ontology application 135 may search for web-based information including thesis, websites, articles, etc., to derive multiple search results that may include sentences having relevant terms, e.g., “chromosome” and “variation.” From among the multiple search results, ontology application 135 may select a search result that has occurred most frequently. For example, if one of the search results that reads “variation is included in chromosome” is determined to occur most frequently among the search results, ontology application 135 may select and divide, with reference to a morphological dictionary, the sentence into a plurality of morphological segments, e.g., “variation,” “is included,” “in,” and “chromosome,” to identify one or more super-concepts, one or more sub-concepts, and the respective relationships between them. The morphological segment may be words, phrases, or even sentences.

Upon dividing the sentence representing the search result having the more occurrences into the morphological segments, ontology application 135 may retrieve “chromosome” as a sub-concept subsumed by the super-concept “variation” and “is included” as a relationship between the sub-concept and the super-concept, based on the predefined table stored in a database corresponding to genome ontology device 130. That is, if the predefined table determines that “chromosome” is subsumed by “variation” and the sentence includes two terms “chromosome” and “variation”, ontology application 135 may retrieve “chromosome” as a sub-concept subsumed by the super-concept “variation”.

Alternatively, if there are no recurring search results in the form of sentences, ontology application 135 may additionally search web-based information utilizing a scheme to analyze a frequency of particular terms. Then, ontology application 135 may derive a plurality of phrases and/or terms as search results that may be sorted based on frequency of occurrence. Based on one or more phrases and/or terms placed within a predefined ranking, e.g., 1st and 2nd among the sorted phrases and/or terms, ontology application 135 may divide the one or more phrases and/or terms into a plurality of morphological segments, and retrieve one or more sub-concepts and one or more corresponding relationships, with reference to the predefined table. Ontology application 135 may be further configured or operable to, after retrieving the sub-concepts and the relationships from the first genome database, identify one or more of the sub-concepts corresponding to the field values of the first genome database, with reference to the data tables of the first genome data base.

For example, in data table P and data table Q, a portion of the field values, i.e., “1001, 1002, and 1003” may correspond to a sub-concept “position.” A position may refer to where a chromosome is located in the corresponding gene and may be expressed by numbers. In addition, another portion of the field values, e.g., “T, A, C” may correspond to the sub-concept “allele.” Allele may refer to one of a number of alternative forms of the same gene or same genetic locus, and may be represented by one or more alphanumeric characters. The other portion of the field values, e.g., “1,” may correspond to the sub-concept “Chromosome,” which may refer to packaged and organized chromatin, a complex of macromolecules found in cells, consisting of DNA, protein and RNA and may be expressed by one or more alphanumeric characters.

Ontology application 135 may be further configured or operable to arrange each of the corresponding field values in the identified sub-concepts as an instance that may be a basic component of the ontology. For example, a portion of the field values, e.g., “1001, 1002, and 1003” may be arranged in the sub-concept “position,” or another portion of the field values, e.g., “T,” “A,” or “C” may be arranged in the sub-concept “allele,” etc.

In some other embodiments, based on the generated ontology, ontology application 135 may be configured to display a searching user interface (UI) to identify a plurality of sub-concepts that may satisfy a condition determined by a user input. By way of example of user input, after receiving a user input that describes a condition including one or more sub-concepts including user-defined field values such as “position=1001,” ontology application 135 may search on the generated ontology and identify the one or more sub-concepts including the user-defined field values, and the one or more super-concepts subsuming the one or more sub-concepts. Then, ontology application 135 may display, on the user interface, the one or more sub-concepts including the user-defined field values, and the one or more super-concepts subsuming the one or more sub-concepts.

Thus, FIG. 1 shows an example system 10 in which one or more embodiments of genome ontology schemes may be implemented, in accordance with various embodiments described herein.

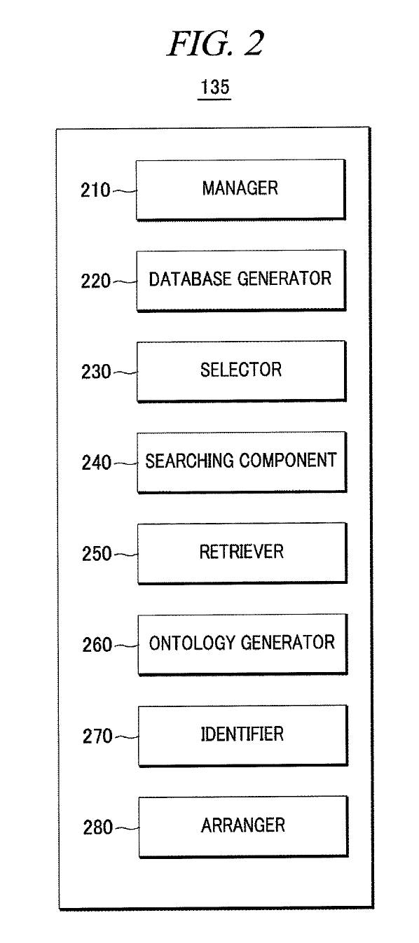

FIG. 2 shows an example application by which at least portions of a genome ontology scheme may be implemented, in accordance with various embodiments described herein. As depicted in FIG. 2, ontology application 135, hosted, executable, and/or operable on genome ontology device 130 may include a manager 210 configured to determine one or more super-concepts to be included in an ontology; a database generator 220 configured to generate a first genome database, from a genome, that includes at least one first title, at least one first field name and at least one first field values; a selector 230 configured to select, from among the one or more super-concepts, one or more super-concepts that correspond to the first genome database; a searching component 240 configured to search on web-based information with at least one first key word associated with the one or more super-concepts and the first database; a retriever 250 configured to retrieve, from results of the search, a plurality of sub-concepts subsumed by the one or more super-concepts and one or more relationships between the one or more super-concepts and the plurality of sub-concepts; and an ontology generator 260 configured to generate the ontology based on the super-concepts, the retrieved sub-concepts, and the retrieved relationships.

In some embodiments, manager 210 may be configured or operable to determine one or more super-concepts to be included in an ontology. A super-concept may refer to a higher concept that may be determined by a user input to genome ontology device 130. Non-limiting examples of super-concepts associated with a genome may include diseases, variations, genes, and drugs.

Database generator 220 may be configured or operable to generate, after determining one or more super-concepts, a first genome database that may include one or more data tables. The generated data tables may each include a title, a field name including, e.g., a plurality of segments such as chromosome, position, allele, etc., and field values corresponding to the respective segments of the field name.

For example, database generator 220 may generate a first genome database that includes a data table titled “P” (for gene “P”). As an example of the data table, data table P may be provided as: a gene P's chromosome, which is packaged and organized chromatin, a complex of macromolecules found in cells, consisting of DNA, protein and RNA and that may have a plurality of chromosome numbers, as a field value; a position of gene P's chromosome within gene P, as gene P's field name, that may indicate where the chromosome is located in gene P and that may be shown in a form of 4 digit numbers(in gene P, there may be many locations where chromosome can be located), as a field value; and an allele, as a field name, that is one of a number of alternative forms of the same gene or same genetic locus and that may include alphabet as in field value.

Selector 230 may be configured or operable to select one or more of the determined super-concepts that correspond to the first genome database. That is, genome ontology device 130 may select a super-concept corresponding to a field name included in a genome database. As a non-limiting example, if the first genome database includes both “data table P”, each of which may include “Chromosome,” “Position,” and “Allele” as the respective field names, genome ontology device 130 may select “variation” as a super-concept corresponding to “data table P”, based on a table predefining certain corresponding relationships between field names and super-concepts that indicates that “Chromosome,” “Position,” and “Allele” may be included in “variation” of the corresponding gene.

Searching component 240 may be configured or operable to search web-based information using at least one keyword associated with the selected super-concept and the first database for multiple sentences including the keyword. For example, genome ontology device 130 may generate two keywords including at least one of the titles, the field names, and the field values included “data table P” and the selected super-concept “variation.” As an example of the two keywords, genome ontology device 130 may generate the keywords including “chromosome” and “variation” to be used to search for the multiple sentences including the keywords that may produce a structured, precisely defined vocabulary for describing the genes and gene products.

Searching component 240 may search for web-based information including academic papers, websites, articles, etc., to derive multiple search results that may include sentences having relevant terms, e.g., “chromosome” and “variation.” From among the multiple search results, genome ontology device 130 may select a search result that has occurred most frequently to be divided into a plurality of morphological segments, e.g., “variation,” “is included,” “in,” and “chromosome,” to identify one or more super-concepts, one or more sub-concepts, and the corresponding relationships between them.

Retriever 250 may be configured to retrieve, from results of the search, a plurality of sub-concepts subsumed by the one or more super-concepts and one or more relationships between the one or more super-concepts and the plurality of sub-concepts. For example, upon dividing the sentence representing the search result having the more occurrences into the morphological segments, retriever 250 may retrieve “chromosome” as a sub-concept subsumed by the super-concept “variation” and “is included” as a relationship between the sub-concept and the super-concept, based on the predefined table stored in genome ontology device 130.

Ontology generator 260 may be configured to generate the ontology based on the super-concepts, the retrieved sub-concepts, and the retrieved relationships. That is, ontology generator 260 may identify one or more of the sub-concepts corresponding to the field values of the first genome database, with reference to the data tables of the first genome data base.

For example, in data table P and data table Q, a portion of the field values, i.e., “1001, 1002, and 1003”, may correspond to a sub-concept “position.” In addition, another portion of the field values, e.g., “T, A, C” may correspond to the sub-concept “allele.” The other portion of the field values, e.g., “1,” may correspond to the sub-concept “Chromosome”.

Thus, FIG. 2 shows an example application by which at least portions of a genome ontology scheme may be implemented, in accordance with various embodiments described herein.

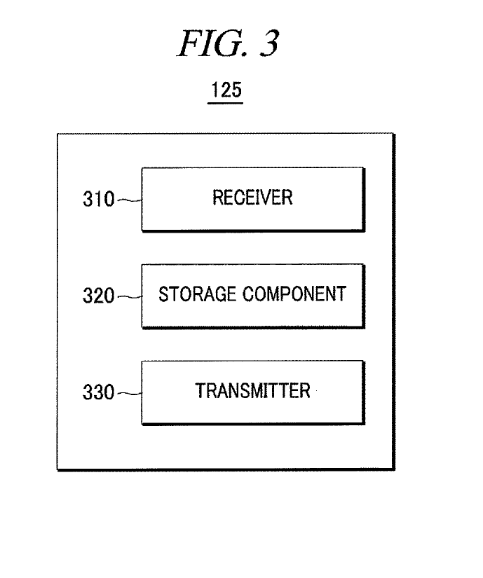

FIG. 3 shows an example application by which at least portions of a genome ontology scheme may be implemented, in accordance with various embodiments described herein. As depicted in FIG. 3, application 125 hosted, executable, and/or operable on genome server 120 may include a receiver 310 configured to receive a request from ontology application 135 on genome ontology device 130 to transmit one or more data tables stored in genome server 120 to ontology application 135 on genome ontology device 130, a storage component 320 configured to store information regarding a user's genome, and a transmitter 330 configured to transmit the one or more requested data tables to genome ontology server 130.

Receiver 310 may be configured to receive a request from ontology application 135 to transmit one or more data tables stored on or corresponding to genome server 120 to ontology application 135. That is, receiver 310 may receive a query for data table retrieval from the genome database through a computer network or data network that is a telecommunications network that allows computers to exchange data. In computer networks, receiver 310 may receive genome data along data connections. Data may be transferred in the form of packets. The connections (network links) between nodes may be established using either cable media or wireless technologies.

Storage component 320 may be configured to store information regarding a user's genome in memory that may refer to the physical devices used to store programs (sequences of instructions) or data on a permanent basis for use in a genome server 120.

Transmitter 330 may be configured to transmit the one or more requested data tables to genome ontology server 130.

Thus, FIG. 3 shows an example application by which at least portions of a genome ontology scheme may be implemented, in accordance with various embodiments described herein.

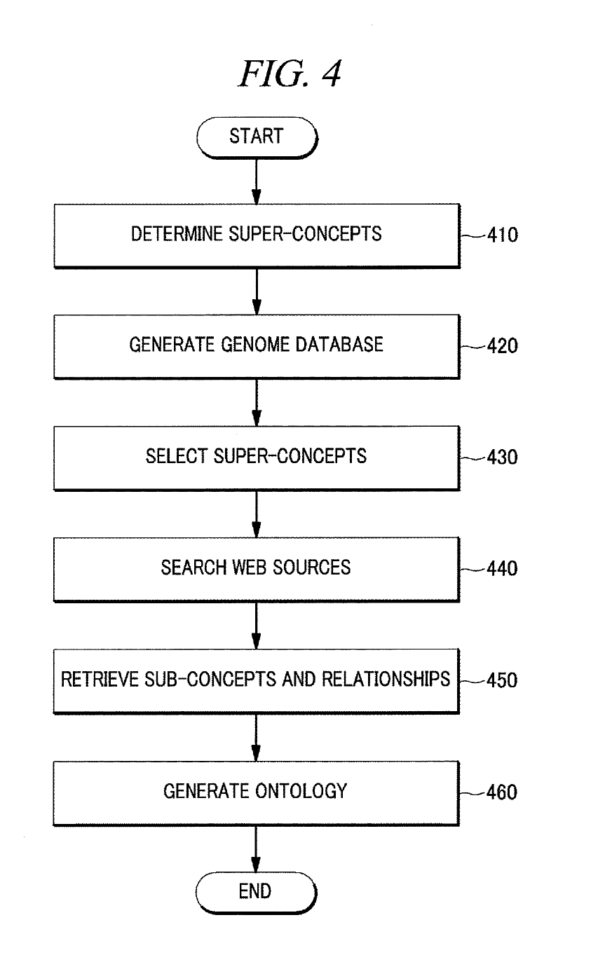

FIG. 4 shows an example processing flow of operations, by which at least portions of genome ontology schemes may be implemented, in accordance with various embodiments described herein. The operations of processing flow 400 may be implemented in system configuration 10 including network 110, genome server 120, application 125, genome ontology device 130 and ontology application 135, as illustrated in and described with regard to FIG. 1.

Processing flow 400 may include one or more operations, actions, or functions as illustrated by one or more blocks 410, 420, 430, 440, 450, and/or 460. Although illustrated as discrete blocks, various blocks may be divided into additional blocks, combined into fewer blocks, or eliminated, depending on the desired implementation. Processing may begin at block 410.

Block 410 (Determine Super-Concepts) may refer to manager 210 determining one or more super-concepts to be included in an ontology. A super-concept may refer to a higher concept that may be determined by a user input to genome ontology device 130. Non-limiting examples of super-concepts associated with a genome may include diseases, variations, genes, and drugs. Processing may proceed from block 410 to block 420.

Block 420 (Generate Genome Database) may refer to database generator 220 generating, after determining one or more super-concepts, a first genome database that may include one or more data tables. The generated data tables may each include a title, a field name including, e.g., a plurality of segments such as chromosome, position, allele, etc., and field values corresponding to the respective segments of the field name.

For example, database generator 220 may generate a first genome database that includes a data table titled “P” (for gene “P”). As an example of the data table, data table P may be provided as: a gene P's chromosome in field value; a position of gene P's chromosome within gene P in gene P's field name; and an allele, as in field name, that is one of a number of alternative forms of the same gene or same genetic locus and that may include alphabet as in field value. Processing may proceed from block 420 to block 430.

Block 430 (Select Super-Concepts) may refer to selector 230 selecting one or more of the determined super-concepts that correspond to the first genome database. That is, selector 230 may select a super-concept corresponding to a field name included in a genome database. As a non-limiting example, if the first genome database includes both “data table P” and “data table Q,” each of which may include “Chromosome,” “Position,” and “Allele” as the respective field names, selector 230 may select “variation” as a super-concept corresponding to “data table P” and “data table Q,” based on a table predefining certain corresponding relationships between field names and super-concepts that indicates that “Chromosome,” “Position,” and “Allele” may be included in “variation” of the corresponding gene. Processing may proceed from block 430 to block 440.

Block 440 (Search Web Sources) may refer to searching component 240 searching web-based information using at least one keyword associated with the selected super-concept and the first database for multiple sentences including the keyword. For example, searching component 240 may generate two keywords including at least one of the titles, the field names, and the field values included “data table P” and the selected super-concept “variation.” As an example of the two keywords, searching component 240 may generate the keywords including “chromosome” and “variation” to be used to search for the multiple sentences including the keywords that may produce a structured, precisely defined vocabulary for describing the roles of genes and gene products.

Searching component 240 may search for web-based information including thesis, websites, articles, etc., to derive multiple search results that may include sentences having relevant terms, e.g., “chromosome” and “variation.” From among the multiple search results, selector 230 may select a search result that has occurred most frequently. Processing may proceed from block 440 to block 450.

Block 450 (Retrieve Sub-Concepts And Relationships) may refer to retriever 250 dividing, with reference to a morphological dictionary, the search result into a plurality of morphological segments, e.g., “variation,” “is included,” “in,” and “chromosome”, to identify super-concept, sub-concept, and the relationship between them.

Upon dividing the sentence representing the search result having the more occurrences into the morphological segments, retriever 250 may retrieve “chromosome” as a sub-concept subsumed by the super-concept “variation” and “is included” as a relationship between the sub-concept and the super-concept, based on the predefined table stored in genome ontology device 130. Processing may proceed from block 450 to block 460.

Block 460 (Generate Ontology) may refer to ontology generator 260 generating the ontology based on the super-concepts, the retrieved sub-concepts, and the retrieved relationships. That is, ontology generator 260 may identify one or more of the sub-concepts corresponding to the field values of the first genome database, with reference to the data tables of the first genome data base.

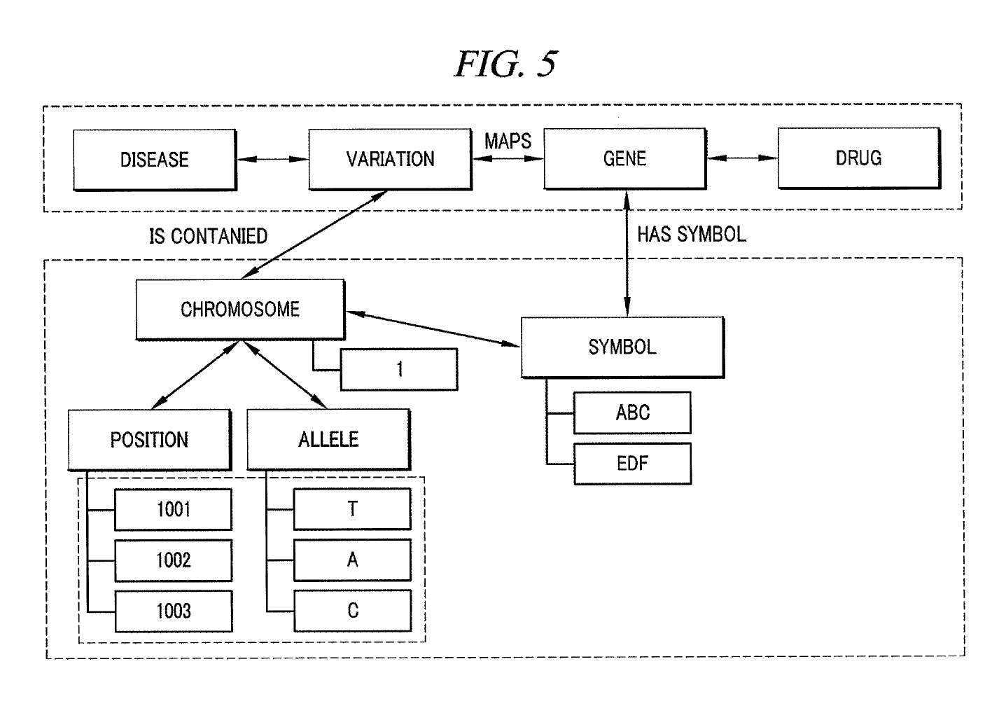

For example, in data table P and data table Q, a portion of the field values, i.e., “1001, 1002, and 1003” may correspond to a sub-concept “position.” In addition, another portion of the field values, e.g., “T, A, C” may correspond to the sub-concept “allele.” The other portion of the field values, e.g., “1,” may correspond to the sub-concept “Chromosome”. Thus, as depicted FIG. 5, “1” may be located under “Chromosome”, “1001, 1002, and 1003” may be located under “Position”, and “T, A, C” may be located under “allele”.

Thus, FIG. 4 shows an example processing flow of operations, by which at least portions of genome ontology schemes may be implemented, in accordance with various embodiments described herein.

FIG. 5 shows an example embodiment implemented by at least portions of genome ontology schemes, in accordance with various embodiments described herein. Database generator 220 may generate a first genome database that includes a data table titled “P” (for gene “P”) and another data table titled “Q” (for gene “Q”).

As an example of the data table, data table P may be provided as: a gene P's chromosome, and P's chromosome may have a plurality of chromosome numbers, as in field value; a position of gene P's chromosome within gene P, as in gene P's field name, that may indicate where the chromosome is located in gene P and that may be shown in a form of 4 digit numbers (in gene P, there may be many locations where chromosome can be located), as in field value; and an allele, as in field name, and that may include alphabet as in field value.

| | | |
|---|---|---|
| chromosome | Position | Allele |

Gene P

| | | |
|---|---|---|
| 1 | 1001 | T |
| 1 | 1002 | A |

Gene Q

| | | |
|---|---|---|
| 1 | 1001 | T |
| 1 | 1003 | C |

As depicted in FIG. 5, the first genome database includes both “data table P” and “data table Q,” each of which may include “Chromosome,” “Position,” and “Allele” as the respective field names, selector 230 may select “variation” as a super-concept corresponding to “data table P” and “data table Q,” based on a table predefining certain corresponding relationships between field names and super-concepts that indicates that “Chromosome,” “Position,” and “Allele” may be included in “variation” of the corresponding gene.

Searching component 240 may search web-based information using at least one keyword associated with the selected super-concept and the first database for multiple sentences including the keyword, such as “chromosome” and “variation”. From among the multiple search results, selector 230 may select a search result that has occurred most frequently.

For example, if one of the search results that reads “variation is included in chromosome” is determined to occur most frequently among the search results, selector 230 may select and divide, with reference to a morphological dictionary, the sentence into a plurality of morphological segments, e.g., “variation,” “is included,” “in,” and “chromosome”, to identify super-concept, sub-concept, and the relationship between them.

Also, retriever 250 may retrieve “chromosome” as a sub-concept subsumed by the super-concept “variation” and “is included” as a relationship between the sub-concept and the super-concept, based on the predefined table stored in genome ontology device 130.

Ontology generator 260 may identify one or more of the sub-concepts corresponding to the field values of the first genome database, with reference to the data tables of the first genome data base.

For example, in data table P and data table 4, a portion of the field values, i.e., “1001, 1002, and 1003”, may correspond to a sub-concept “position.” In addition, another portion of the field values, e.g., “T, A, C”, may correspond to the sub-concept “allele.” The other portion of the field values, e.g., “1,” may correspond to the sub-concept “Chromosome”. Thus, as depicted FIG. 5, “1” may be located under “Chromosome”, “1001, 1002, and 1003” may be located under “Position”, and “T, A, C” may be located under “allele”.

Thus, FIG. 5 shows an example embodiment implemented by at least portions of genome ontology schemes, in accordance with various embodiments described herein.

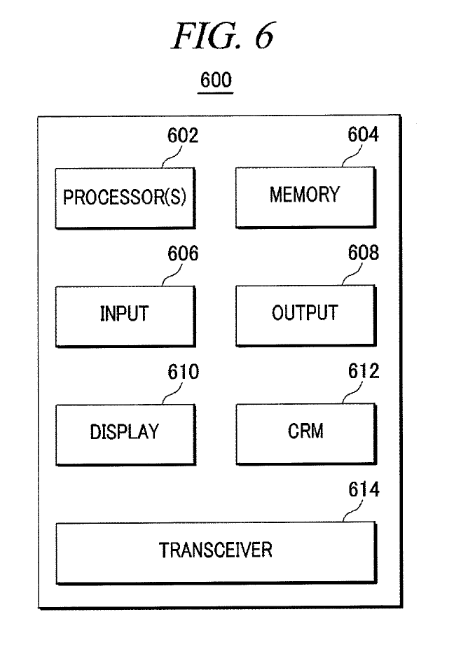

FIG. 6 shows an illustrative computing embodiment, in which any of the processes and sub-processes of a genome ontology scheme may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 600 may typically include, at least, one or more processors 602, a system memory 604, one or more input components 606, one or more output components 608, a display component 610, a computer-readable medium 612, and a transceiver 614.

Processor 602 may refer to, e.g., a microprocessor, a microcontroller, a digital signal processor, or any combination thereof.

Memory 604 may refer to, e.g., a volatile memory, non-volatile memory, or any combination thereof. Memory 604 may store, therein, an operating system, an application, and/or program data. That is, memory 604 may store executable instructions to implement any of the functions or operations described above and, therefore, memory 604 may be regarded as a computer-readable medium.

Input component 606 may refer to a built-in or communicatively coupled keyboard, touch screen, or telecommunication device. Alternatively, input component 606 may include a microphone that is configured, in cooperation with a voice-recognition program that may be stored in memory 604, to receive voice commands from a user of computing device 600. Further, input component 606, if not built-in to computing device 600, may be communicatively coupled thereto via short-range communication protocols including, but not limitation, radio frequency or Bluetooth.

Output component 608 may refer to a component or module, built-in or removable from computing device 600, that is configured to output commands and data to an external device.

Display component 610 may refer to, e.g., a solid state display that may have touch input capabilities. That is, display component 610 may include capabilities that may be shared with or replace those of input component 606.

Computer-readable medium 612 may refer to a separable machine readable medium that is configured to store one or more programs that embody any of the functions or operations described above. That is, computer-readable medium 612, which may be received into or otherwise connected to a drive component of computing device 600, may store executable instructions to implement any of the functions or operations described above. These instructions may be complimentary or otherwise independent of those stored by memory 604.

Transceiver 614 may refer to a network communication link for computing device 600, configured as a wired network or direct-wired connection. Alternatively, transceiver 614 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

Thus, FIG. 6 shows an illustrative computing embodiment, in which any of the processes and sub-processes of a genome ontology scheme may be implemented as computer-readable instructions stored on a computer-readable medium, in accordance with various embodiments described herein.

We claim:

1. A method performed under control of a genome ontology device, comprising:
determining one or more super-concepts to be included in an ontology;
generating a first genome database, from a genome, that includes at least one first title, at least one first field name and at least one first field value;
selecting, from among the one or more super-concepts, one or more super-concepts that correspond to the first genome database;
searching web-based sources using at least one first key word associated with the one or more super-concepts and the first database;
retrieving, from results of the search, a plurality of sub-concepts subsumed by the one or more super-concepts and one or more respective relationships between the one or more super-concepts and the plurality of sub-concepts; and
generating the ontology based on the super-concepts, the retrieved sub-concepts, and the retrieved relationships.

2. The method of claim 1, wherein the generating of the ontology includes:
identifying, from among the plurality of sub-concepts, one or more sub-concepts corresponding to each of the at least one first field values; and
arranging each of the at least one first field values in the identified one or more sub-concepts.

3. The method of claim 1, wherein the one or more super-concepts include variations, genes, diseases, and drugs.

4. The method of claim 1, wherein the selecting comprises selecting, based on the at least one first field name of the first genome database, the super-concepts that correspond to the first genome database.

5. The method of claim 1, wherein the searching includes searching on web-based information by utilizing a scheme for analyzing a frequency of term usage.

6. The method of claim 1, wherein the retrieving includes:
selecting a result from among results of the searching based on a frequency of occurrence of the result;
dividing the selected result into a plurality of segments; and
retrieving, from the plurality of segments, the plurality of sub-concepts and the one or more relationships between the one or more super-concepts and the plurality of sub-concepts.

7. The method of claim 6, wherein the retrieving includes:
sorting the plurality of segments in accordance with a frequency of occurrence in the results of the searching; and
identifying the plurality of sub-concepts and the one or more relationships, based on one or more of the sorted segments placed within a predefined ranking.

8. The method of claim 1, further comprising:
generating a second genome database, from the genome, that includes at least one second title, at least one second field name and at least one second field values;
selecting, from among the one or more super-concepts, a second set of one or more super-concepts corresponding to the second genome database;
searching the web-based sources with at least one second key word associated with the second set of one or more super-concepts and the second genome database; and
retrieving, from results of the searching with the at least one second key word, a plurality of second sub-concepts subsumed by the second set of one or more super-concepts and one or more second relationships between the second set of one or more super-concepts and the plurality of second sub-concepts.

9. The method of claim 8, further comprising:
identifying, from among the plurality of second sub-concepts, one or more second sub-concepts corresponding to each of the at least one second field values; and
arranging each of the at least one second field values in the identified one or more second sub-concepts.

10. The method of claim 1, further comprising:
displaying a user interface for receiving at least one input to identify, from among the plurality of sub-concepts, one or more sub-concepts including user-defined field values and one or more super-concepts subsuming the one or more sub-concepts, and
wherein the user interface includes one or more corresponding channels for receiving each of the at least one input.

11. The method of claim 10, further comprising:
identifying, based on the at least one input, the one or more sub-concepts including the user-defined field values, and the one or more super-concepts subsuming the one or more sub-concepts; and
displaying, on the user interface, the one or more sub-concepts including the user-defined field values, and the one or more super-concepts subsuming the one or more sub-concepts.

12. A genome ontology device, comprising:
a manager configured to determine one or more super-concepts to be included in an ontology;
a database generator configured to generate a first genome database, from a genome, that includes at least one first title, at least one first field name and at least one first field values;
a selector configured to select, from among the one or more super-concepts, one or more super-concepts that correspond to the first genome database;
a searching component configured to search web-based sources using at least one first key word associated with the one or more super-concepts and the first database;
a retriever configured to retrieve, from results of the search, a plurality of sub-concepts subsumed by the one or more super-concepts and one or more respective relationships between the one or more super-concepts and the plurality of sub-concepts; and
an ontology generator configured to generate the ontology based on the super-concepts, the retrieved sub-concepts, and the retrieved relationships.

13. The genome ontology device of claim 12, wherein the ontology generator is further configured to identify, from among the plurality of sub-concepts, one or more sub-concepts corresponding to each of the at least one first field values, and
wherein the ontology generator is still further configured to arrange each of the at least one first field values in the identified one or more sub-concepts.

14. The genome ontology device of claim 12, wherein the one or more super-concepts include variations, genes, diseases, and drugs.

15. The genome ontology device of claim 12, wherein the selecting comprises selecting, based on the at least one first field title of the first genome database, the super-concepts that correspond to the first genome database.

16. The genome ontology device of claim 12, wherein the retrieving includes:
selecting a result from among results of the searching based on a frequency of occurrence of the result;
dividing the selected result into a plurality of segments; and
retrieving, from the plurality of segments, the plurality of sub-concepts and the one or more respective relationships between the one or more super-concepts and the plurality of sub-concepts.

17. The genome ontology device of claim 16, wherein the retrieving includes:
sorting the plurality of segments in accordance with a frequency of occurrence in the results of the search; and
identifying the plurality of sub-concepts and the one or more relationships, based on one or more of the sorted segments placed within a predefined ranking.

18. The genome ontology device of claim 13, wherein the database generator is further configured to generate a second genome database, from the genome, that includes at least one second title, at least one second field name and at least one second field values,
wherein the selector is further configured to select, from among the one or more super-concepts, a second set of one or more super-concepts corresponding to the second genome database,
wherein the searching component is further configured to search the web-based sources using at least one second key word associated with the second set of one or more super-concepts and the second database, and
wherein the retriever is further configured to retrieve, from results of the search, a plurality of second sub-concepts subsumed by the second set of one or more super-concept and second respective relationships between the second set of one or more super-concepts and the plurality of second sub-concepts.

19. The genome ontology device of claim 18, wherein the ontology generator is still further configured to identify, from among the plurality of second sub-concepts, one or more second sub-concepts corresponding to each of the at least one second field values, and
wherein the ontology generator is still further configured to arrange each of the at least one second field values in the identified one or more second sub-concepts.

20. A computer-readable storage medium having thereon computer-executable instructions that, in response to execution, cause a genome ontology device to perform operations, comprising:
determining one or more super-concepts to be included in an ontology;
generating a first genome database, from a genome, that includes at least one first title, at least one first field name and at least one first field value;
selecting, from among the one or more super-concepts, one or more super-concepts that correspond to the first genome database;
searching web-based sources using at least one first key word associated with the one or more super-concepts and the first database;
retrieving, from results of the search, a plurality of sub-concepts subsumed by the one or more super-concepts and one or more respective relationships between the one or more super-concepts and the plurality of sub-concepts; and
generating the ontology based on the super-concepts, the retrieved sub-concepts, and the retrieved relationships.

21. The computer-readable storage medium of claim 20, wherein the generating of the ontology includes:
identifying, from among the plurality of sub-concepts, one or more sub-concepts corresponding to each of the at least one first field values; and
arranging each of the at least one first field values in the identified one or more sub-concepts.
